(19) United States
(12) Patent Application Publication
(10) Pub. No.: US 2019/0220803 A1
(43) Pub. Date: Jul. 18, 2019

(54) INFORMATION PROCESSING SYSTEM AND INFORMATION PROCESSING METHOD

(71) Applicant: TOYOTA JIDOSHA KABUSHIKI KAISHA, Toyota-shi (JP)

(72) Inventors: Kei KANAOKA, Nagoya-shi (JP); Shun MAEDA, Nisshin-shi (JP); Yoshihiro MUROZAKI, Nisshin-shi (JP); Hiroko TSUJIMURA, Nagoya-shi (JP); Daiki KANEICHI, Nisshin-shi (JP); Kuniaki JINNAI, Nagoya-shi (JP)

(73) Assignee: TOYOTA JIDOSHA KABUSHIKI KAISHA, Toyota-shi (JP)

(21) Appl. No.: 16/233,177

(22) Filed: Dec. 27, 2018

(30) Foreign Application Priority Data
Jan. 12, 2018 (JP) 2018-003681

(51) Int. Cl. G06Q 10/08; G07C 9/00

(52) U.S. Cl. CPC G06Q 10/083; G07C 2009/00468; G07C 9/00309; G07C 9/00896

(57) ABSTRACT

An information processing system includes an evaluation setting unit configured to, on evaluation items for evaluating a user who requests a pick-up and delivery agent who has picked up or delivered the package to pick-up the package from an inside of a vehicle cabin of a vehicle, receive and store evaluation results for the evaluation items from a terminal of the pick-up and delivery agent, and a privilege providing unit configured to provide, based on the evaluation results, information of a privilege to be given to the user who has requested the pick-up or delivery of the package.

### INCORPORATION BY REFERENCE

The disclosure of Japanese Patent Application No. 2018-003681 filed on Jan. 12, 2018 including the specification, drawings and abstract is incorporated herein by reference in its entirety.

### BACKGROUND

### 1. Technical Field

The present disclosure relates to an information processing system and an information processing method.

### 2. Description of Related Art

As means for efficiently performing hand-over of a pick-up/delivery article (hereinafter, referred to as a “package”) between a user (hereinafter, referred to as a “user”) of a pick-up and delivery service and a delivery company that performs pick-up and delivery of the package, a trunk sharing system that uses the inside of a vehicle cabin of a vehicle designated by the user as a hand-over place of the pick-up/delivery article has been developed. For example, Japanese Unexamined Patent Application Publication No. 2006-206225 (JP 2006-206225 A) discloses a system that, in performing hand-over of a pick-up/delivery article, performs mutual authentication with a package receiving vehicle which receives a package using a business communicator provided in a vehicle of a home delivery company to house the pick-up/delivery article in a trunk and allows an addressee to receive the pick-up/delivery article with the vehicle which receives the package.

### SUMMARY

Like the trunk sharing system, in a system that performs pick-up and delivery of a package using a vehicle, a vehicle designated as a pick-up/delivery destination may not be present at a place designated as a pick-up/delivery destination or at a designated time. Even though the vehicle is present, there may be no loading space in the vehicle due to a loaded package or when the size of a package to be picked up or delivered may be greater than the loading space. In such a case, adjustment of re-pick-up/delivery with the user is needed, causing degradation in efficiency of a pick-up/delivery work.

The disclosure provides an information processing system and an information processing method capable of contributing to improvement of efficiency of a pick-up/delivery work with the inside of a vehicle cabin of a vehicle as a hand-over place of a pick-up/delivery article.

A first aspect of the disclosure relates to an information processing system. The information processing system includes an evaluation setting unit and a privilege presentation unit. The evaluation setting unit configured to, on evaluation items for evaluating a user who requests a pick-up and delivery agent who picks up or delivers the package to pick-up the package from an inside of a vehicle cabin of a vehicle, receive and store evaluation results for the evaluation items from a terminal of the pick-up and delivery agent who picked up or delivered the package. The privilege providing unit configured to provide, based on the evaluation results, information of a privilege to be given to the user who has requested the pick-up or delivery of the package.

A package to be picked up or delivered is loaded inside a vehicle cabin of a vehicle including a space inside the vehicle for allowing an occupant to get in the vehicle or a space for housing the package. Examples of the evaluation items include items of whether or not a vehicle is present on pick-up or delivery date and time and at a pick-up or delivery place designated by the user, whether or not a delivery vehicle enters the designated pick-up or delivery place, whether or not there is a change request of the designated pick-up or delivery date and time or pick-up or delivery place, whether or not there is a space at which a pick-up/delivery article can be loaded inside the vehicle, and the like. Examples of the privilege to be given to the user include a discount of a delivery charge, delivery with priority over other users, a gift, and the like.

In the above-described information processing system, the privilege to be given to the user is provided based on the evaluation results for the user from the pick-up and delivery agent. The privilege is displayed, for example, on a screen for requesting new pick-up or delivery or a screen for receiving the privilege to be given based on the evaluation results. Since the user can receive various privileges, the user is motivated to stop the vehicle at the designated pick-up or delivery place on the designated pick-up or delivery date and time to improve the evaluation results. Accordingly, the efficiency of a pick-up/delivery work in which a pick-up/delivery article is picked-up from or delivered to the inside of the vehicle cabin of the vehicle, which corresponds to a hand-over place of the pick-up/delivery article, is improved.

The information processing system according to the first aspect of the disclosure may further include a user evaluation unit configured to reward points to the user based on the evaluation results. The privilege providing unit is configured to provide the information of the privilege to be given to the user based on the rewarded points. The information processing system rewards the points to the user based on the evaluation results for the user from the pick-up and delivery agent. The user can receive various privileges using the rewarded points. The user is motivated to improve the evaluation results in order to receive various privileges. With this, the efficiency of the pick-up/delivery work is improved.

The information processing system according to the first aspect of the disclosure may further include a vehicle monitoring unit configured to acquire information of a situation in the vicinity of the vehicle or a loading situation inside the vehicle. The evaluation setting unit may be configured to, when detection is made that the vehicle is stopped at a pick-up or delivery place designated by the user, set a first evaluation result for a situation evaluation item corresponding to the situation in the vicinity of the vehicle or the loading situation inside the vehicle acquired by the vehicle monitoring unit among the evaluation items.

The situation in the vicinity of the vehicle is, for example, a situation as to whether opening and closing of a door of the vehicle is not disturbed by an obstacle, such as another vehicle, or a situation as to whether a path to a stop position of the vehicle is not blocked. The loading situation inside the vehicle is, for example, a situation in which a loading space in the inside of the vehicle cabin of the vehicle is empty. The evaluation setting unit defines an evaluation item and a corresponding evaluation value in advance, thereby setting the evaluation result (first evaluation result) for the situation evaluation item when the vehicle is stopped at the pick-up or delivery place. The situation in the vicinity of the vehicle or the loading situation inside the vehicle is detectable by monitoring the inside and the outside of the vehicle using a device that detects an obstacle, such as a clearance sonar in the vehicle.

The above-described information processing system can evaluate the situation evaluation item corresponding to the situation in the vicinity of the vehicle or the loading situation inside the vehicle in advance before the package is picked up or delivered. For this reason, the information processing system can properly evaluate the user based on a situation when the user stops the vehicle at the pick-up or delivery place.

In the information processing system according to the aspect of the disclosure, the evaluation setting unit may be configured to, when a second evaluation result for the situation evaluation item included in the evaluation results for the evaluation items received from the terminal of the pick-up and delivery agent who has picked up or delivered the package is lower than the first evaluation result, re-evaluate the situation evaluation item based on the first evaluation result and the second evaluation result for the situation evaluation item.

The pick-up and delivery agent inputs the evaluation results for the evaluation items of the user to the terminal of the pick-up and delivery agent when the package is picked up or delivered. However, when the situation in the vicinity of the vehicle or the loading situation inside the vehicle is changed until the package is picked up or delivered after the user stops the vehicle at the pick-up or delivery place, the information processing system may not properly evaluate the user even though the vehicle is stopped at a place where the package can be picked up or delivered. That is, the evaluation result (second evaluation result) from the pick-up and delivery agent for the situation evaluation item among the evaluation items may become lower than the evaluation result (first evaluation result) when the vehicle is stopped. In this case, the user is re-evaluated based on the first evaluation result and the second evaluation result, whereby it is possible to perform proper evaluation of the user according to a situation when the vehicle is stopped. The evaluation result is converted to a numerical value according to a predetermined rule for each evaluation item, whereby it is possible to perform level evaluation.

In the information processing system according to the aspect of the disclosure, the situation evaluation item may include at least one of (i) ease of access to the pick-up or delivery place designated by the user, (ii) the presence or absence of a change request of pick-up or delivery date and time or the pick-up or delivery place designated by the user, and (iii) package housability inside the vehicle.

In the information processing system according to the first aspect of the disclosure, the evaluation item may include at least one of (i) the presence or absence of a vehicle on pick-up or delivery date and time and at the pick-up or delivery place designated by the user, and (ii) the presence or absence of a change request of the pick-up or delivery date and time or the pick-up or delivery place designated by the user.

The information processing system according to the aspect of the disclosure may further include a pick-up and delivery management unit configured to, when the vehicle is not present on the pick-up or delivery date and time and at the pick-up or delivery place designated by the user, transmit notification for prompting to change a pick-up and delivery plan to the terminal of the pick-up and delivery agent who picks up or delivers the package. With this, since the pick-up and delivery agent can change a pick-up and delivery plan before reaching the pick-up or delivery place, it is possible to achieve the efficiency of the pick-up/delivery work. The pick-up and delivery plan is a schedule that defines a pick-up/delivery order for efficiently picking up or delivering the package.

In the information processing system according to the aspect of the disclosure, the pick-up and delivery management unit may be configured to, when the vehicle is not present at the pick-up or delivery place a predetermined time before the pick-up or delivery date and time, transmit notification for prompting the vehicle to move to the pick-up or delivery place to a terminal of the user. With this, the information processing system can suppress the occurrence of a situation in which the vehicle is not present as the pick-up/delivery destination at the pick-up or delivery place on the pick-up or delivery date and time. The predetermined time can be, for example, a time needed until the vehicle moves to the pick-up or delivery place. The time needed until the vehicle moves to the pick-up or delivery place can be estimated from the distance between a current position of the vehicle and the pick-up or delivery place.

The information processing system according to the aspect of the disclosure may be constituted of one or a plurality of processing devices, such as computers. When the information processing system is constituted of a plurality of processing devices, the configurations of the information processing system are distributed in the processing devices, and the processing devices cooperatively realize processing as the information processing system.

In the information processing system according to the first aspect of the disclosure, the privilege to be given to the user may include any one of (i) a discount of a delivery charge of the package, (ii) delivery with priority over other users, and (iii) a gift.

A second aspect of the disclosure relates to an information processing method. The information processing method includes, with a computer, on evaluation items for evaluating a user who requests a pick-up and delivery agent who picks up or delivers the package to pick-up the package from an inside of a vehicle cabin of a vehicle, receiving and storing evaluation results for the evaluation items from a terminal of the pick-up and delivery agent, and with the computer, providing, based on the evaluation results, information of a privilege to be given to the user who has requested the pick-up or delivery of the package. A technical idea disclosed regarding the information processing system described above can also be applied to the information processing method within a range in which a technical contradiction does not occur.

According to the aspects of the disclosure, it is possible to contribute to improvement of the efficiency of the pick-up/delivery work with the inside of the vehicle cabin of the vehicle as the hand-over place of the pick-up/delivery article.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram showing the schematic configuration of an information processing system according to an embodiment;

FIG. 2 is a block diagram schematically illustrating the configurations of an in-vehicle device, a user terminal of a pick-up/delivery user, a user terminal of a request user, a pick-up and delivery management server, and a center server constituting the information processing system shown in FIG. 1;

FIG. 3 is a table illustrating a data structure of evaluation item information that is stored in the pick-up and delivery management server;

FIG. 4 is a table illustrating a data structure of request user information that is stored in the pick-up and delivery management server;

FIG. 5 is a table illustrating a data structure of providing privilege information that is stored in the pick-up and delivery management server;

FIG. 6 is a table illustrating a data structure of pick-up and delivery information that is stored in the pick-up and delivery management server;

FIG. 7 is a table illustrating a data structure of vehicle management information that is stored in the pick-up and delivery management server;

FIG. 8 is a diagram illustrating a request user evaluation screen where a pick-up/delivery user evaluates a request user;

FIG. 9 is a diagram illustrating a pick-up/delivery request screen where the request user registers pick-up and delivery information of a package;

FIG. 10 is a flowchart illustrating request user evaluation processing that is executed by the pick-up and delivery management server; and

FIG. 11 is a flowchart illustrating re-evaluation processing of the request user that is executed by the pick-up and delivery management server.

### DETAILED DESCRIPTION OF EMBODIMENTS

Hereinafter, a specific embodiment will be described referring to the drawings. Configurations described in the example are not intended to limit the technical scope of the disclosure unless particularly described.

### First Embodiment

System Configuration

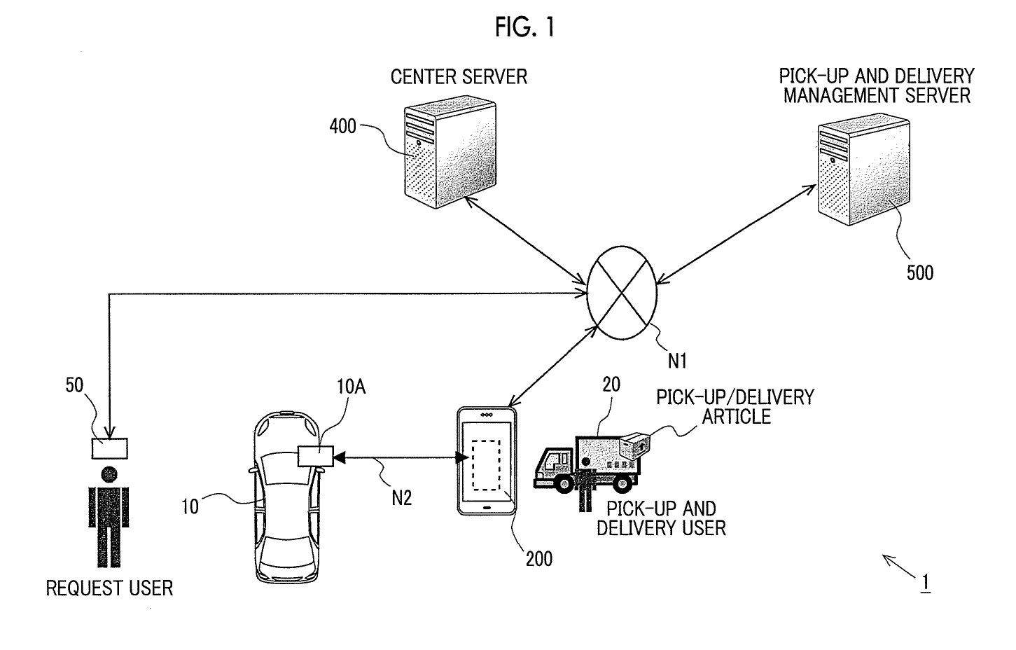

FIG. 1 is a diagram showing the schematic configuration of an information processing system 1 according to the embodiment. The information processing system 1 is a system that shares the inside of a vehicle cabin of a vehicle 10 designated by a person who requests a pick-up/delivery work of a pick-up/delivery article (package) between the person who requests the pick-up/delivery work of the pick-up/delivery article and a person who performs the requested pick-up/delivery work of the pick-up/delivery article, thereby realizing a pick-up/delivery service with the inside of the vehicle cabin of the vehicle 10 as a hand-over place. The inside of the vehicle cabin of the vehicle 10 is a space including a space (hereinafter, referred to as a “vehicle cabin”) inside the vehicle for allowing an occupant to get in the vehicle or a space (hereinafter, referred to as a “trunk”) for housing the package. Accordingly, while each of “the person who requests the pick-up/delivery work of the pick-up/delivery article” and “the person who performs the pick-up/delivery work of the pick-up/delivery article” is a user who uses the inside of the vehicle cabin of the vehicle 10, in order to distinguish between both users, the former is referred to as a “request user”, and the latter is referred to as a “pick-up/delivery user”. The request user is an example of a “user”, and the pick-up/delivery user is an example of a “pick-up/delivery agent”.

In the example of FIG. 1, the information processing system 1 includes an in-vehicle device 10A that is provided in a vehicle 10, a delivery vehicle 20 that is used for pick-up and delivery, a user terminal 200 of the pick-up/delivery user, a user terminal 50 of the request user, a center server 400, and a pick-up and delivery management server 500. The in-vehicle device 10A, the user terminal 200 of the pick-up/delivery user, the user terminal 50 of the request user, the center server 400, and the pick-up and delivery management server 500 are connected to one another through a network N1. The network N1 may be, for example, a worldwide public communication network, such as the Internet, and a wide area network (WAN) or other communication networks may be employed. The network N1 may include a telephone communication network for a mobile phone, and a wireless communication network, such as WiFi. The in-vehicle device 10A is connected to the user terminal 200 of the pick-up/delivery user through a network N2 including short-range wireless communication or the like. While one pick-up and delivery management server 500 is illustratively included in the information processing system 1, two or more pick-up and delivery management servers may be included in the information processing system 1. The user terminal 200 of the pick-up/delivery user is an example of “a terminal of a pick-up/delivery agent”, and the user terminal 50 of the request user is an example of “a terminal of a user”.

The pick-up and delivery management server 500 receives registration of an article (hereinafter, referred to as a “package” or a “pick-up/delivery article”) to be picked up or delivered from the user terminal 50 of the request user. For example, when an article that the request user purchases on a commodity purchase site established by an electronic commerce company is made to be delivered as the pick-up/delivery article by the pick-up/delivery user, the request user can register pick-up and delivery information relating to the pick-up/delivery article in the pick-up and delivery management server 500 with an application (hereinafter, referred to as a “predetermined application”) for using a service of the information processing system 1 installed on the user terminal 50 of the request user. The pick-up and delivery information includes at least one of identification information of the request user, information of pick-up/delivery date and time, a pick-up/delivery place, and earned points of the request user for receiving various services, and the like. The identification information of the request user is also associated in advance with the vehicle 10 associated with the request user in the pick-up and delivery management server 500. The request user can select and designate a pick-up/delivery place to be used from candidates of the pick-up/delivery place including the vehicle 10 related to the request user. The selected pick-up/delivery place is included in the pick-up and delivery information. In the following description, description will be provided assuming that the pick-up/delivery place designated by the request user is the vehicle 10. The pick-up and delivery information also includes information relating to a status of the pick-up/delivery article. As the status information, information regarding whether or not pick-up/delivery of the package is completed or the like can be exemplified.

The pick-up and delivery management server 500 receives a request for the pick-up/delivery of the package from the user terminal 50 of the request user. The pick-up and delivery management server 500 transmits the pick-up and delivery information registered by the request user to the user terminal 200 of the pick-up/delivery user. The pick-up/delivery user starts to move the pick-up/delivery place included in the pick-up and delivery information.

When the pick-up/delivery user reaches the vehicle 10 stopped at the pick-up/delivery place, the pick-up/delivery user requests the center server 400 to issue authentication information for locking or unlocking the vehicle cabin or the trunk of the vehicle 10 as a pick-up/delivery destination of the package to the user terminal 200 of the pick-up/delivery user. Locking or unlocking of the trunk or the vehicle cabin of the vehicle 10 may be hereinafter simply referred to as “locking or unlocking of the vehicle 10” when there is no need for distinction between the trunk and the vehicle cabin. The request for the authentication information to the center server 400 is performed with the request from the user terminal 200 of the pick-up/delivery user as a starting point. The center server 400 transmits the authentication information of the vehicle 10 associated with the identification information of the request user to the user terminal 200 of the pick-up/delivery user through the pick-up and delivery management server 500 based on the identification information of the request user included in the pick-up and delivery information. The pick-up/delivery user locks or unlocks the vehicle 10 using the authentication information acquired by the user terminal 200 of the pick-up/delivery user, thereby accessing the inside of the vehicle cabin of the vehicle 10 in order to deliver or pick up the pick-up/delivery article. The authentication information is digital information that is transferred from the user terminal 200 of the pick-up/delivery user to the in-vehicle device 10A through short-range wireless communication, is subjected to authentication processing in the in-vehicle device 10A, and makes the in-vehicle device 10A execute locking and unlocking processing of the trunk of the vehicle 10. The locking and unlocking processing of the vehicle 10 is processing for locking or unlocking a door for accessing the inside of the vehicle cabin of the vehicle 10 housing the pick-up/delivery article with the in-vehicle device 10A. Details of the in-vehicle device 10A will be described below.

When the pick-up/delivery work of the pick-up/delivery article is completed or interrupted, the pick-up/delivery user evaluates the request user. A case where the pick-up/delivery work of the pick-up/delivery article is interrupted includes, for example, a case where the vehicle 10 is not present as the pick-up/delivery destination at the designated pick-up/delivery place, a case where there is an obstacle in the vicinity of the vehicle 10 and the door of the vehicle 10 is hardly opened and closed, a case where there is no loading space for housing the pick-up/delivery article in the inside of the vehicle cabin of the vehicle 10, and the like. When pick-up or delivery is interrupted, the pick-up/delivery user adjusts a pick-up/delivery plan and changes an order of picking up or delivering the pick-up/delivery article. The request user is rewarded points based on evaluation results from the pick-up/delivery user. The request user can receive a privilege based on the evaluation results or the rewarded points.

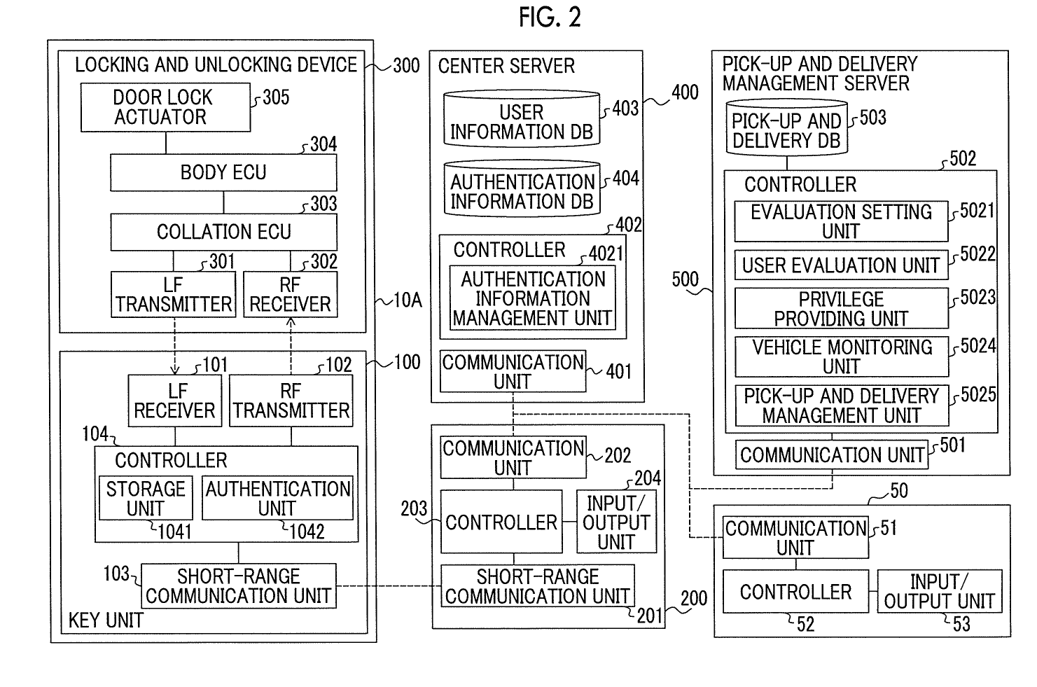

FIG. 2 is a block diagram schematically illustrating the configurations of the in-vehicle device 10A, the user terminal 200 of the pick-up/delivery user, the user terminal 50 of the request user, the pick-up and delivery management server 500, and the center server 400 constituting the information processing system 1. The hardware configurations and the functional configurations of the in-vehicle device 10A, the user terminal 200 of the pick-up/delivery user, the user terminal 50 of the request user, the pick-up and delivery management server 500, and the center server 400 will be described referring to FIG. 2.

The in-vehicle device 10A includes a key unit 100 and a locking and unlocking device 300. The key unit 100 has the same wireless interface as an electronic key (hereinafter, referred to as a “portable device”) of a smart key, and performs communication with the existing locking and unlocking device 300 in the in-vehicle device 10A, thereby performing locking and unlocking of the vehicle 10 without using a physical key. The key unit 100 performs short-range wireless communication with the user terminal 200 of the pick-up/delivery user, and decides whether or not the key unit 100 operates as an electronic key of the vehicle 10 based on a result of the authentication processing on the user terminal 200 of the pick-up/delivery user.

When the inside of the vehicle cabin of the vehicle 10 is accessed in order to delivery or pick up the package, the user terminal 200 of the pick-up/delivery user makes the authentication information for locking and unlocking of the vehicle 10 be issued to the center server 400 through the pick-up and delivery management server 500 as described above. Then, the authentication information transmitted from the user terminal 200 of the pick-up/delivery user to the key unit 100 is collated with authentication information stored in advance in the key unit 100. When the above-described authentication processing is successful, the user terminal 200 of the pick-up/delivery user is authenticated as a terminal that operates the in-vehicle device 10A in an authorized manner. When the user terminal 200 of the pick-up/delivery user is authenticated, the key unit 100 transmits a key ID of the vehicle 10 stored in advance in the key unit 100 and associated with the authentication information to the locking and unlocking device 300 along with a locking/unlocking signal. When the key ID received from the key unit 100 coincides with a key ID stored in advance in the locking and unlocking device 300, the locking and unlocking device 300 locks or unlocks the vehicle 10. The key unit 100 and the locking and unlocking device 300 operate with electric power that is supplied from a battery mounted in the vehicle 10. The key ID stored in advance in the key unit 100 may be coded by the authentication information. In this case, when the authentication processing of the user terminal 200 of the pick-up/delivery user is successful, the key unit 100 may decode the key ID with the authentication information and then transmit the key ID to the locking and unlocking device 300.

Details of the locking and unlocking device 300 will be described. The locking and unlocking device 300 is a device that locks or unlocks the door of the vehicle cabin or the trunk of the vehicle 10. For example, the door of the vehicle 10 is locked or unlocked according to a locking signal and an unlocking signal transmitted from a portable device corresponding to the vehicle 10 through an electric wave in a radio frequency (hereinafter, referred to as “RF”) band. The locking and unlocking device 300 has a function of transmitting an electric wave in a low frequency (hereinafter, referred to as “LF”) band in order to search for a portable device.

In the embodiment, instead of the portable device, the key unit 100 transmits and receives electric waves in the RF band and the LF band to and from the locking and unlocking device 300, thereby controlling locking and unlocking of the door of the vehicle 10. Subsequently, unless otherwise stated, description will be provided assuming that a communication destination of the locking and unlocking device 300 is limited to the key unit 100.

The locking and unlocking device 300 includes an LF transmitter 301, an RF receiver 302, a collation electronic control unit (ECU) 303, a body ECU 304, and a door lock actuator 305. The LF transmitter 301 is means for transmitting an electric wave in a low frequency band (for example, 100 KHz to 300 KHz) for searching for (polling) the key unit 100. The LF transmitter 301 is incorporated, for example, in the vicinity of a center console or a steering wheel inside the vehicle cabin. The RF receiver 302 is means for receiving an electric wave in a radio frequency band (for example, 100 MHz to 1 GHz) transmitted from the key unit 100. The RF receiver 302 is incorporated at any place inside the vehicle cabin.

The collation ECU 303 is a computer that performs control for locking and unlocking the door of the vehicle cabin or the trunk of the vehicle 10 based on a signal (locking signal or unlocking signal) transmitted from the key unit 100 through an electric wave in an RF band. The collation ECU 303 is constituted of, for example, a microcomputer. In the following description, the locking signal and the unlocking signal are collectively referred to as a locking/unlocking signal. The term “locking/unlocking signal” represents at least one of the locking signal and the unlocking signal.

The collation ECU 303 authenticates that the locking/unlocking signal transmitted from the key unit 100 is transmitted from an authorized device. Specifically, the collation ECU 303 determines whether or not the key ID included in the locking/unlocking signal coincides with a key ID stored in advance in a storage unit (not shown) in the collation ECU 303. Then, the collation ECU 303 transmits a locking command or an unlocking command to the body ECU 304 based on a result of the determination. The locking command or the unlocking command is transmitted through an in-vehicle network, such as a controller area network (CAN).

The door lock actuator 305 is an actuator that locks and unlocks the door (a vehicle cabin door that is opened and closed at the time of getting in and off the vehicle cabin to be a getting-in space or a trunk door that is opened and closed at the time of loading and unloading a package in the trunk) of the vehicle 10. The door lock actuator 305 operates based on a signal transmitted from the body ECU 304. The door lock actuator 305 may be configured to be able to lock and unlock the vehicle cabin door and the trunk door in the vehicle 10 in an independent manner.

The body ECU 304 is a computer that performs body control of the vehicle 10. The body ECU 304 has a function of controlling the door lock actuator 305 based on the unlocking command or the locking command received from the collation ECU 303 to perform unlocking and locking of the vehicle cabin door or the trunk door of the vehicle 10 in a simultaneous or independent manner. The collation ECU 303 and the body ECU 304 may be integrated.

Next, the key unit 100 will be described. The key unit 100 is a device that is disposed at a predetermined position (for example, inside a glove box) inside the vehicle cabin of the vehicle 10. The key unit 100 has a function of performing short-range wireless communication with the user terminal 200 of the pick-up/delivery user or the like to authenticate the user terminal 200 of the pick-up/delivery user, and a function of transmitting the locking/unlocking signal using an electric wave in an RF band based on the authentication result. The key unit 100 has an LF receiver 101, an RF transmitter 102, a short-range communication unit 103, and a controller 104.

The LF receiver 101 is means for receiving a polling signal transmitted from the locking and unlocking device 300 through an electric wave in an LF band. The LF receiver 101 has an antenna (hereinafter, referred to as an LF antenna) for receiving the electric wave in the LF band. The RF transmitter 102 is means for transmitting the locking/unlocking signal to the locking and unlocking device 300 through an electric wave in an RF band.

The short-range communication unit 103 is means for performing communication with the user terminal 200 of the pick-up/delivery user. The short-range communication unit 103 performs communication in a short range (to such a degree that communication can be performed between the inside of the vehicle cabin and the outside of the vehicle cabin) using a predetermined wireless communication standard. In the embodiment, the short-range communication unit 103 performs data communication based on the Bluetooth (Registered Trademark) Low Energy standard (hereinafter, referred to as “BLE”). The BLE is a low power communication standard with Bluetooth, and has a feature that communication can be readily started by detecting a contact without needing pairing between devices. In the embodiment, although the BLE has been illustrated, other wireless communication standards are available. For example, near field communication (NFC), Ultra-wideband (UWB), WiFi (Registered Trademark), and the like may be used.

The controller 104 is a computer that performs short-range wireless communication with the user terminal 200 of the pick-up/delivery user through the short-range communication unit 103, and performs control for authenticating the user terminal 200 of the pick-up/delivery user and control for transmitting the locking/unlocking signal based on the authentication result. The controller 104 is constituted of, for example, a microcomputer.

The controller 104 has a storage unit 1041 and an authentication unit 1042. In the storage unit 1041, a control program for controlling the key unit 100 is stored. The controller 104 may execute the control program stored in the storage unit 1041 on a central processing unit (CPU) (not shown), thereby realizing various functions including the authentication unit 1042. For example, the controller 104 realizes a function of receiving the polling signal transmitted as the electric wave in the LF band from the locking and unlocking device 300 through the LF receiver 101, a function of transmitting the locking/unlocking signal as the electric wave in the RF band to the locking and unlocking device 300 through the RF transmitter 102, a function of processing communication with the user terminal 200 of the pick-up/delivery user through the short-range communication unit 103, a function of generating the locking/unlocking signal when authentication of the user terminal 200 of the pick-up/delivery user with the authentication unit 1042 is successful, and the like.

The authentication unit 1042 performs authentication of the user terminal 200 of the pick-up/delivery user based on authentication information included in a locking request or an unlocking request (hereinafter, collectively referred to as a “locking/unlocking request”) transmitted from the user terminal 200 of the pick-up/delivery user. Specifically, authentication information stored in the storage unit 1041 is compared with the authentication information transmitted from the user terminal 200 of the pick-up/delivery user, and when both of the authentication information have a predetermined relationship, the authentication unit 1042 determines that authentication is successful. When both of the authentication information do not satisfy the predetermined relationship, the authentication unit 1042 determines that the authentication fails. The predetermined relationship includes a case where processing results of predetermined coding and decoding using two pieces of authentication information coincide with each other, a case where a result of decoding processing on one of the two pieces of authentication information coincides with the other authentication information, and the like, in addition to a case where the authentication information stored in the storage unit 1041 and the authentication information transmitted from the user terminal 200 of the pick-up/delivery user coincide with each other.

When the authentication unit 1042 succeeds in authentication of the user terminal 200 of the pick-up/delivery user, the locking/unlocking signal generated according to the request received from the user terminal 200 of the pick-up/delivery user is transmitted to the locking and unlocking device 300 through the RF transmitter 102. Subsequently, according to the need of description, the authentication information stored in the key unit 100 is referred to as device authentication information, and the authentication information transmitted from the user terminal 200 of the pick-up/delivery user is referred to as terminal authentication information.

The key unit 100 transmits the key ID to the locking and unlocking device 300 along with the locking/unlocking signal. The key ID may be stored in the key unit 100 in advance in a state of a plain sentence or may be stored in a state coded with a code specific to the user terminal 200 of the pick-up/delivery user. When the key ID is stored in a coded state, the coded key ID may be decoded with the authentication information transmitted from the user terminal 200 of the pick-up/delivery user to obtain the original key ID.

In this way, the in-vehicle device 10A operates the locking and unlocking device 300 through the authentication processing in the key unit 100 with the authentication information transmitted from the user terminal 200 of the pick-up/delivery user as a starting point, thereby executing a series of locking and unlocking processing for locking and unlocking of the vehicle cabin or the trunk of the vehicle 10.

Next, the user terminal 200 of the pick-up/delivery user will be described. The user terminal 200 of the pick-up/delivery user is, for example, a small computer, such as a smartphone, a mobile phone, a tablet terminal, a personal information terminal, or a wearable computer (smartwatch or the like). The user terminal 200 of the pick-up/delivery user may be a personal computer (PC) that is connected to the pick-up and delivery management server 500 through the network N1, such as the Internet as a public communication network. The user terminal 200 of the pick-up/delivery user has a short-range communication unit 201, a communication unit 202, a controller 203, and an input/output unit 204.

The short-range communication unit 201 is means for performing communication with the key unit 100 based on the same communication standard as the short-range communication unit 103 of the key unit 100. A network that is formed between the short-range communication unit 201 and the key unit 100 is represented by N2 in FIG. 1. Then, the communication unit 202 is communication means for connecting the user terminal 200 of the pick-up/delivery user to the network N1. In the example, the user terminal 200 of the pick-up/delivery user can perform communication with other devices (for example, the pick-up and delivery management server 500 and the like) through the network N1 using a mobile communication service, such as 3rd generation (3G) or long term evolution (LTE).

The controller 203 is a computer that controls the user terminal 200 of the pick-up/delivery user. The controller 203 performs, for example, processing for acquiring the terminal authentication information, processing for generating the locking/unlocking request acquired terminal authentication information, processing for transmitting the generated locking/unlocking request to the key unit 100, and the like. The controller 203 is constituted of, for example, a microcomputer, and causes a CPU to execute a program stored in storage means (read only memory (ROM) or the like) (both are not shown), whereby functions for various kinds of processing described above are realized.

The controller 203 performs interaction with the pick-up/delivery user through the input/output unit 204. The input/output unit 204 is means for receiving an input operation of the pick-up/delivery user and providing information to the pick-up/delivery user. Specifically, the input/output unit 204 is constituted of, a touch panel and control means of the touch panel, and a liquid crystal display and a control means of the liquid crystal display. The touch panel and the liquid crystal display is constituted of one touch panel display in the example.

The controller 203 displays an operation screen on the input/output unit 204 and generates a locking/unlocking request according to an operation of the pick-up/delivery user. For example, the controller 203 outputs an icon for unlocking, an icon for locking, and the like on the touch panel display and generates an unlocking request and a locking request based on of an operation of the pick-up/delivery user. An operation of the pick-up/delivery user is not limited to an operation on the touch panel display. For example, an operation of a hardware switch or the like may be applied. The input/output unit 204 displays various screens to be provided by the predetermined application for using the service of the information processing system 1, such as a screen for evaluating the request user and a screen for changing a delivery schedule.

The controller 203 performs processing for acquiring the terminal authentication information from the center server 400. The terminal authentication information is not information (key ID) that is used when the locking and unlocking device 300 authenticates the key unit 100, but information (for example, authentication information corresponding to authentication information specific to the key unit 100 mounted in the vehicle 10) that is used when the key unit 100 authenticates the user terminal 200 of the pick-up/delivery user. Specifically, the controller 203 transmits an issuance request of the terminal authentication information to the center server 400 through the communication unit 202 by way of the pick-up and delivery management server 500. In “the issuance request of the terminal authentication information” used herein, identification information of the user terminal 200 of the pick-up/delivery user and a signal for requesting to issue the terminal authentication information specific to the key unit 100 are included. When the issuance request of the terminal authentication information is received, the center server 400 transmits the terminal authentication information specific to the key unit 100 mounted in the vehicle 10 to the user terminal 200 of the pick-up/delivery user. With this, an operation to unlock the vehicle 10 is permitted on the user terminal 200 of the pick-up/delivery user. When the user terminal 200 of the pick-up/delivery user does not have the terminal authentication information, a locking operation and an unlocking operation from the operation screen on the vehicle 10 are prohibited.

In the example, the terminal authentication information that is acquired by the user terminal 200 of the pick-up/delivery user may be a one-time key that is invalidated with locking of the trunk door accompanied by the end of the pick-up/delivery work of the pick-up/delivery user as a trigger. For example, at a timing at which the terminal authentication information transmitted from the center server 400 is received by the user terminal 200 of the pick-up/delivery user, the terminal authentication information is stored in a storage unit (not shown) of the user terminal 200 of the pick-up/delivery user. Thereafter, at a timing at which a locking notification that is transmitted from the key unit 100 when locking of the trunk door accompanied by the end of the pick-up/delivery work is performed is received by the user terminal 200 of the pick-up/delivery user, the terminal authentication information is erased from the storage unit.

The timing at which the terminal authentication information stored in the storage unit of the user terminal 200 of the pick-up/delivery user is erased is not limited to the above-described example, may be a timing at which a predetermined time has elapsed after the terminal authentication information transmitted from the center server 400 is received by the user terminal 200 of the pick-up/delivery user (or when the center server 400 transmits the terminal authentication information toward the user terminal 200 of the pick-up/delivery user). The terminal authentication information is not limited to the one-time key described above, and may be a limited key that is valid solely in a predetermined time slot. Then, it is assumed that the device authentication information corresponding to the terminal authentication information is stored in advance in the key unit 100 regardless of whether the terminal authentication information is a one-time key or a limited key.

Next, the user terminal 50 of the request user will be described. Similarly to the user terminal 200 of the pick-up/delivery user, the user terminal 50 of the request user may be, for example, a small computer, such as smartphone, a mobile phone, a tablet terminal, a personal information terminal, or a wearable computer (smartwatch or the like), or may be a personal computer. The user terminal 50 of the request user has a communication unit 51, a controller 52, and an input/output unit 53.

The communication unit 51 is communication means for connection to the network N1 like the communication unit 202 in terms of functions. The controller 52 is a computer that controls the user terminal 50 of the request user. The controller 52 is constituted of, for example, a microcomputer, and causes a CPU (not shown) to execute a program stored in storage means (ROM or the like), whereby functions of performing various kinds of processing are realized. For example, the controller 52 executes the predetermined application to request the pick-up and delivery management server 500 of a predetermined delivery company for pick-up and delivery of a package through the input/output unit 53. The input/output unit 53 is means for receiving an input operation of the request user and providing information to the request user like the input/output unit 204 in terms of functions. The input/output unit 53 displays various screens to be provided by the predetermined application for using the service of the information processing system 1, such as a screen that is used when the request user registers information of the request user and a screen that is used to input information for requesting pick-up and delivery.

In FIG. 2, the user terminal 50 of the request user does not explicitly have a configuration corresponding to the short-range communication unit 201. Meanwhile, the user terminal 50 of the request user may have such a configuration, and may be configured to allow the controller 52 to perform processing for acquiring the terminal authentication information from the center server 400 to transmit the terminal authentication information to the key unit 100 through short-range wireless communication like the controller 203, such that the locking and unlocking device 300 is operated from the user terminal 50 of the request user.

Next, the pick-up and delivery management server 500 will be described. The pick-up and delivery management server 500 has a configuration of a general computer, and when a plurality of delivery companies participate in the information processing system 1, each delivery company prepares at least one pick-up and delivery management server as a management server for each delivery company. The pick-up and delivery management server 500 is a computer having a processor (not shown), such as a CPU or a digital signal processor (DSP), a main storage unit (not shown), such as a random access memory (RAM) or a ROM, and an auxiliary storage unit (not shown), such as an erasable programmable ROM (EPROM), a hard disk drive (HDD), or a removable medium. The removable medium is, for example, a universal serial bus (USB) memory or a disc recording medium, such as a compact disc (CD) or a digital versatile disc (DVD). In the auxiliary storage unit, an operating system (OS), various programs, various tables, and the like are stored. The programs stored in the auxiliary storage unit are loaded in a work area of the main storage unit and executed, and the constituent units are controlled with the execution of the programs, thereby realizing functions conforming to a predetermined purpose.

The pick-up and delivery management server 500 has a communication unit 501. The communication unit 501 is connected to other devices and performs communication between the pick-up and delivery management server 500 and other devices (for example, the center server 400, the user terminal 200 of the pick-up/delivery user, and the like). The communication unit 501 is, for example, a local area network (LAN) interface board or a wireless communication circuit for wireless communication. The LAN interface board or the wireless communication circuit is connected to the network N1, such as the Internet as a public communication network.

The pick-up and delivery management server 500 has a pick-up and delivery management database (DB) 503 that stores the pick-up and delivery information and evaluation information relating to evaluation of the request user. The evaluation information includes information of evaluation items, evaluation results for the request user, points rewarded based on the evaluation results, a total of earned points of the request user, and the like. The pick-up and delivery management DB 503 is formed in such a way that the pick-up and delivery information and the evaluation information are stored in the auxiliary storage unit, and in the pick-up and delivery management DB 503, the request user and the pick-up and delivery information are associated with each other. The pick-up and delivery management DB 503 is constructed in such a way that a program of a database management system (DBMS) to be executed by a processor manages data stored in the auxiliary storage unit. The pick-up and delivery management DB 503 is, for example, a relational database.

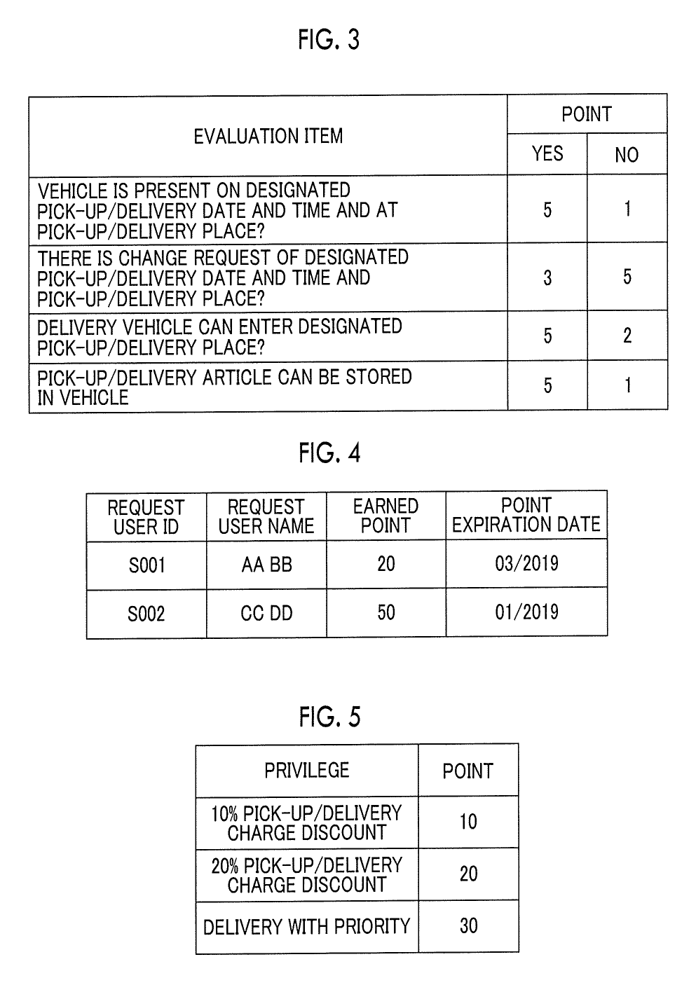

The configurations of the pick-up and delivery information and the evaluation information to be stored in the pick-up and delivery management DB 503 will be described referring to FIGS. 3 to 7. FIG. 3 illustrates a data structure of evaluation item information. An evaluation item table that stores the evaluation item information defines evaluation items that are used when the pick-up/delivery user evaluates the request user. The evaluation item table has fields of evaluation item and point.

The evaluation item field stores an item that is used when the pick-up/delivery user evaluates the request user. The point field stores points to be rewarded according to a reply to an evaluation item. The example of FIG. 3 defines points that are rewarded when the reply to the evaluation item is “YES” and “NO”. For example, when the pick-up/delivery user replies “YES” to an evaluation item “VEHICLE IS PRESENT ON DESIGNATED PICK-UP/DELIVERY DATE AND TIME AND AT PICK-UP/DELIVERY PLACE?”, five points are rewarded, and when the pick-up/delivery user replies “NO”, one point is rewarded. The reply to the evaluation item is not limited to “YES” and “NO”, and a plurality of replies may be provided according to the content of the evaluation item and points of the replies may be defined. A range of points to be rewarded may be defined on each evaluation item, and the pick-up/delivery user may input points within the defined range to evaluate the request user. In regard to an evaluation item “THERE IS CHANGE REQUEST OF DESIGNATED PICK-UP/DELIVERY DATE AND TIME AND PICK-UP/DELIVERY PLACE?”, points to be rewarded may be defined according to the number of change requests. The evaluation items are not limited to the example shown in FIG. 3, and may include items of the number of changes of a pick-up/delivery plan, a frequency of a pick-up/delivery request, and the like.

FIG. 4 illustrates a data structure of request user information. A request user table that stores the request user information manages information relating to the request user, such as the earned points of the request user. The request user table has fields of request user ID, request user name, earned point, and point expiration date.

The request user ID field stores identification information for specifying the request user. The request user ID field may be registered, for example, from the predetermined application in the user terminal 50 of the request user. The request user name field stores the name of the request user. The earned point field stores a total of points rewarded to the request user based on the evaluation results for the request user from the pick-up/delivery user. The request user can be provided with various privileges relating to pick-up/delivery using the earned points when requesting for pick-up/delivery. When the request user is provided with various privileges relating to pick-up/delivery, the earned points of the request user are decreased by used points. The point expiration date field stores an expiration date of the rewarded points. In regard to the points, the number of points may be managed at every reward timing, and an expiration date according to the reward timing may be set.

FIG. 5 illustrates a data structure of privilege information. A privilege table that stores the privilege information defines privileges that the request user can receive using the points. The privilege table has fields of privilege and point. In the embodiment, although an example that a privilege is provided based on points will be described, a privilege may be provided based on an evaluation result in the privilege table. In this case, the privilege table is provided with an evaluation result field, and the evaluation results and the privileges can be associated with each other.

The privilege field stores the content of a privilege that the request user can receive in relation to the pick-up/delivery of the package. Examples of the privilege that the request user can receive include a discount of a delivery charge, delivery with priority over other users, exchange with a gift, and the like. The point field store points to be used to receive various privileges relating to the pick-up/delivery of the package. In the example of FIG. 5, the request user can obtain a 10% discount of a pick-up/delivery charge using ten points. Furthermore, the request user can receive a privilege of delivery with priority using 30 points, for example. The delivery with priority is a privilege that the package of the request user is made to be delivered with priority among a plurality of packages to be picked up or delivered in the same time slot of the same date.

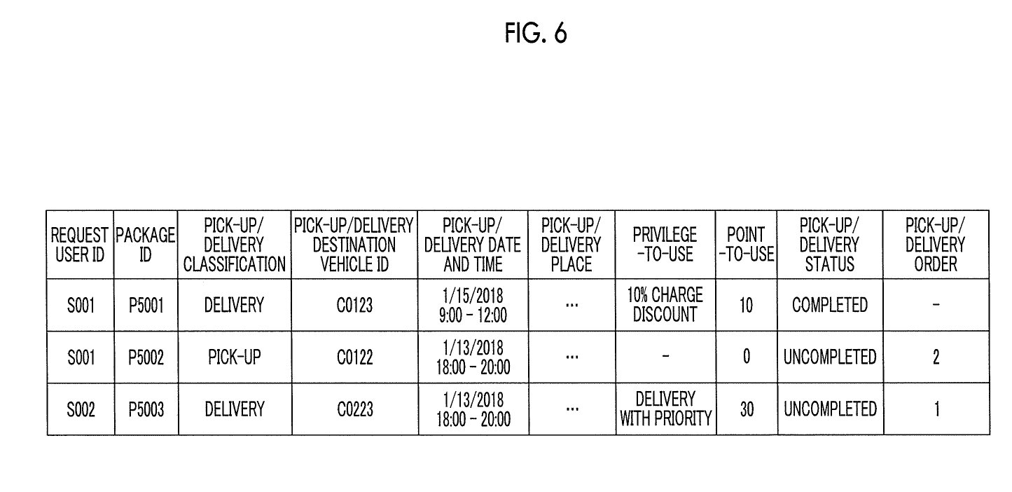

FIG. 6 illustrates a data structure of pick-up and delivery information. A pick-up and delivery information table that stores the pick-up and delivery information manages information that the pick-up/delivery user uses for the pick-up/delivery of the package. The pick-up and delivery information table has fields of request user ID, package ID, pick-up/delivery classification, pick-up/delivery destination vehicle ID, pick-up/delivery date and time, pick-up/delivery place, privilege-to-use, point-to-use, pick-up/delivery status, and pick-up/delivery order.

The request user ID field stores the identification information for specifying the request user. The package ID field stores identification information of a package to be delivered or picked up. The package ID may be, for example, a slip number that is assigned to a package to be picked up or delivered by the delivery company. The pick-up/delivery classification field stores information for specifying whether a package is delivered or picked up by the pick-up/delivery user. The pick-up/delivery destination vehicle ID field stores identification information of the vehicle 10 that the request user designates as a pick-up/delivery destination. The pick-up/delivery destination vehicle ID is the identification information of the vehicle 10 that is registered in association with the request user ID in advance by the predetermined application. The pick-up/delivery date and time field stores information of pick-up/delivery date and pick-up/delivery time when the request user desires the pick-up/delivery of the package. The pick-up/delivery time may be a specific time or may be a specific time slot when pick-up/delivery is requested. The pick-up/delivery place field stores information of a pick-up/delivery place where the request user desires the pick-up/delivery of the package. The request user stops the vehicle 10 as the pick-up/delivery destination on date and time designated as the pick-up/delivery date and time and at a place designated as the pick-up/delivery place, whereby the pick-up/delivery of the package with the vehicle 10 as a hand-over place becomes possible.

The privilege-to-use field stores information of a privilege that the request user uses using the points rewarded based on the evaluation results from the pick-up/delivery user. The point-to-use field relates to points to be used for a privilege that the request user uses. Although it is assumed that the request user uses points in order to receive a privilege, such as a discount or delivery with priority, when requesting the pick-up/delivery of the package, points may be used at a timing other than the time of the request for pick-up/delivery depending on the content of a privilege, such as exchange with a gift.

The pick-up/delivery status field stores information representing whether or not the pick-up/delivery user completes the pick-up/delivery of the package. The pick-up/delivery status is set to “COMPLETED” when the pick-up/delivery of the package is completed, and is set to “UNCOMPLETED” when the pick-up/delivery of the package is not completed. The pick-up/delivery order field stores the pick-up/delivery order of the package having the pick-up/delivery status of “UNCOMPLETED”.

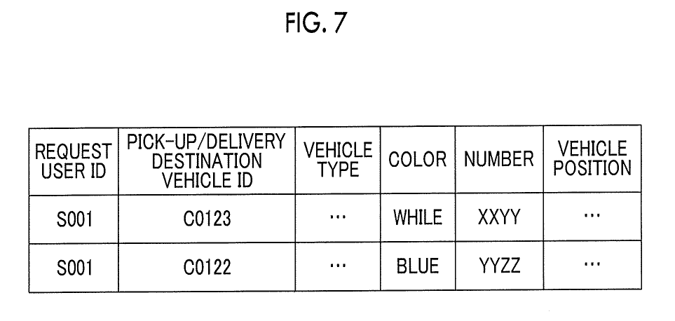

FIG. 7 illustrates a data structure of vehicle management information. A vehicle management information table that stores the vehicle management information manages information that is used when the pick-up/delivery user specifies the vehicle 10 designated as the pick-up/delivery destination. The vehicle management information table has fields of request user ID, pick-up/delivery destination vehicle ID, vehicle type, color, number information, and vehicle position.

The request user ID field stores the identification information for specifying the request user. The pick-up/delivery destination vehicle ID field stores the identification information of the vehicle 10 that is associated with the request user. The request user may be associated with a plurality of vehicles 10. In this case, the request user can designate the different vehicle 10 as the pick-up/delivery destination for each package to be picked up or delivered. The vehicle type, color, and number information fields store information (a vehicle type, the color of the vehicle, and number information) for identifying the vehicle 10 such that the pick-up/delivery user can find the vehicle 10 designated as the pick-up/delivery destination. The vehicle position field stores positional information of the vehicle 10. As the vehicle position, the positional information of the vehicle 10 that the center server 400 ascertains through a data communication device (not shown) in the vehicle 10 can be acquired from the center server 400. The pick-up and delivery management server 500 acquires the positional information of the vehicle 10 from the center server 400, for example, at a predetermined interval, thereby determining whether or not the vehicle 10 is stopped at the pick-up/delivery place.

Then, as shown in FIG. 2, in the pick-up and delivery management server 500, a controller 502 is formed as a functional unit with the execution of the programs by the above-described processor. The controller 502 performs management and control for registration, update, and the like of the pick-up and delivery information and the evaluation information in the pick-up and delivery management DB 503, and management and control for evaluation to the request user and point rewarding. The controller 502 has an evaluation setting unit 5021, a user evaluation unit 5022, a privilege providing unit 5023, a vehicle monitoring unit 5024, and a pick-up and delivery management unit 5025.

The evaluation setting unit 5021 receives, from the user terminal 200 of the pick-up/delivery user, the evaluation results for the request user who requests for the pick-up/delivery of the package. The received evaluation results are stored (set) in the pick-up and delivery management DB 503. The pick-up/delivery user evaluates the request user who requests for the pick-up/delivery of the package when the pick-up/delivery work of the package is completed or interrupted. The interruption of the pick-up/delivery work refers to a case where the pick-up/delivery of the package is not completed and the pick-up/delivery work of the package is hardly continued.

The user evaluation unit 5022 rewards points to the request user who requests the pick-up/delivery of the package based on the evaluation results for the request user received by the evaluation setting unit 5021. Specifically, for example, the user evaluation unit 5022 converts the evaluation results for the request user received by the evaluation setting unit 5021 to points based on the evaluation item table shown in FIG. 3. For example, the user evaluation unit 5022 totalizes points to each evaluation item and calculates points to be rewarded to the request user. The user evaluation unit 5022 may give a weight for each evaluation item and may calculate points to be rewarded to the request user. The user evaluation unit 5022 adds the calculated points to the earned points of the request user in the request user table shown in FIG. 4 to update the earned points of the request user.

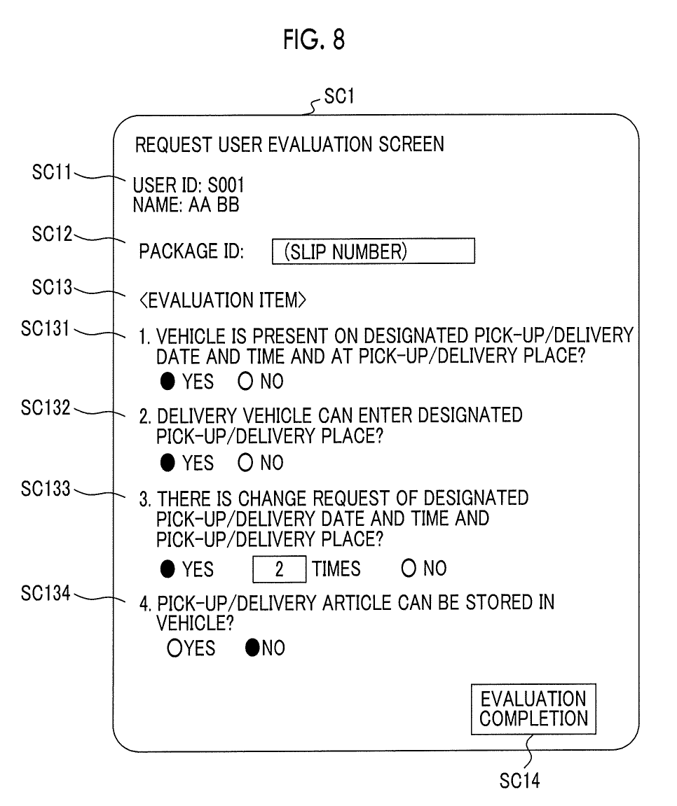

A screen where the pick-up/delivery user evaluates the request user who requests for the pick-up/delivery of the package will be described referring to FIG. 8. FIG. 8 illustrates a request user evaluation screen where the pick-up/delivery user evaluates the request user. A request user evaluation screen SC1 is a screen that is displayed on the input/output unit 204 of the user terminal 200 of the pick-up/delivery user, and receives, from the pick-up/delivery user, an input of evaluation to the request user who requests the pick-up/delivery of the package. On the request user evaluation screen SC1, columns of request user information SC11 (ID, name), a package ID SC12, and evaluation item SC13, and an evaluation completion button SC14 with a label “evaluation completion” are shown.

The request user information SC11 (user ID, name) is a column that is provided to display information of the request user. Information of the request user is registered in advance in the pick-up and delivery management server 500, for example, by the predetermined application. The package ID SC12 is a column that is provided to input the identification information of the package. The package ID may be, for example, a slip number of the package or may be numbered in the pick-up and delivery management server 500 at the time of registration of the pick-up and delivery information.

The evaluation item SC13 is an item for evaluating the request user. In the example of FIG. 8, the evaluation item SC13 includes a column SC131 that is provided to select whether or not the vehicle 10 is present at the designated pick-up/delivery place on the designated pick-up/delivery date and time, a column SC132 that is provided to select whether or not the delivery vehicle 20 can enter the designated pick-up/delivery place, a column SC133 that is provided to select whether or not there is a change request of the designated pick-up/delivery date and time or the designated pick-up/delivery place and inputting the number of changes when there is a change request, and a column SC134 that is provided to select whether or not the pick-up/delivery article can be housed inside the vehicle.

The evaluation completion button SC14 is an operation button that is used to transmit the evaluation results selected or input on the request user evaluation screen SC1 to the pick-up and delivery management server 500. When the evaluation completion button SC14 is depressed, the pick-up and delivery management server 500 receives the evaluation results for the request user, and rewards points based on the evaluation results for the request user with the evaluation setting unit 5021 and the user evaluation unit 5022.

The privilege providing unit 5023 shown in FIG. 2 provides, to the request user, information of privileges that the request user can receive using the earned points. The privilege providing unit 5023 acquires the earned points of the request user with reference to the request user table shown in FIG. 4. The privilege providing unit 5023 can extract information of privileges that the request user can receive within the earned points with reference to the privilege table shown in FIG. 5, and can provide information of privileges to given to the request user. The privilege providing unit 5023 can transmit the extracted information of privileges to the user terminal 50 of the request user or can provide the extracted information of privileges when the request user requests for pick-up/delivery of a new package.

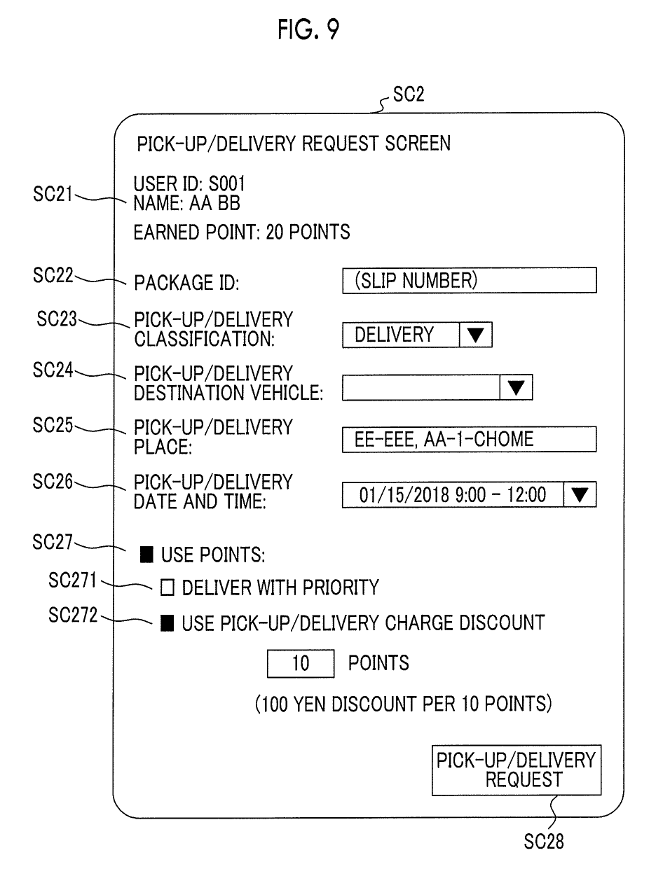

A screen where input operations of the request user to request for the pick-up/delivery of the package and to use the points are received through the input/output unit 53 of the user terminal 50 of the request user will be described referring to FIG. 9. FIG. 9 illustrates a pick-up/delivery request screen that is used when the request user registers the pick-up and delivery information of the package. A pick-up/delivery request screen SC2 is provided by the predetermined application for using the service of the information processing system 1. On the pick-up/delivery request screen SC2, columns of request user information SC21 (ID, name, earned point), package ID SC22, pick-up/delivery classification SC23, pick-up/delivery destination vehicle SC24, pick-up/delivery place SC25, pick-up/delivery date and time SC26, and use points SC27, and a pick-up/delivery request button SC28 with a label “pick-up/delivery request” are shown.

The request user information SC21 (user ID, name, earned points) is a column that is provided to display information of the request user. The user ID and name of the request user information are registered in advance by the predetermined application, for example. The package ID SC22 is a column that is provided to input the identification information of the package. The package ID may be, for example, a slip number of the package or may be numbered in the pick-up and delivery management server 500 at the time of registration of the pick-up and delivery information. The pick-up/delivery classification SC23 is a column that is provided to select a classification regarding whether to deliver or to pick up the package to be picked up or delivered. The pick-up/delivery destination vehicle SC24 is a column that is provided for the request user to select the vehicle 10 to be designated as the pick-up/delivery destination of the package. In the pick-up/delivery destination vehicle SC24, for example, the vehicle 10 registered in association with the request user in advance is presented as an option by the predetermined application. The pick-up/delivery place SC25 is a column that is provided to input a place designated as the pick-up/delivery destination by the request user. The request user inputs, in the column of pick-up/delivery place SC25, an address of a position where the vehicle 10 as the pick-up/delivery destination is stopped, for example. The pick-up/delivery date and time SC26 is a column that is provided to select a date and a time slot that the request user desires the pick-up/delivery of the package.

The column of use points SC27 is a column that is provided to select whether or not to use the points. In the example of FIG. 9, in the column of use points SC27, a column of delivery with priority SC271 and a column of pick-up/delivery charge discount SC272 are displayed. The column of delivery with priority SC271 is a column that is provided to select whether or not to use a privilege of delivery with priority. The column of pick-up/delivery charge discount SC272 is a column that is provided to select whether or not to use a discount privilege of a pick-up/delivery charge. A discount rate of the pick-up/delivery charge may be changed by inputting the number of points to be used. Information of a privilege to be displayed in the column of use points SC27, that is, a privilege that the request user can receive may be changed based on the evaluation results for the request user or the earned points.

The pick-up/delivery request button SC28 is an operation button that is used to transmit information selected or input on the pick-up/delivery request screen SC2 as the pick-up and delivery information to the pick-up and delivery management server 500. When the pick-up/delivery request button SC28 is depressed, the pick-up and delivery management server 500 stores the received pick-up and delivery information in the pick-up and delivery information table shown in FIG. 6.

The vehicle monitoring unit 5024 shown in FIG. 2 monitors a situation in the vicinity of the vehicle 10 designated as the pick-up/delivery place, or the like. The situation in the vicinity of the vehicle 10 includes, for example, a situation as to whether or not there is an obstacle, such as another vehicle, in the vicinity of the vehicle 10 or a situation as to whether or not opening/closing of the door is possible, and the like. A loading situation inside the vehicle 10 includes a situation as to whether or not a package other than a package to be picked up or delivered is loaded inside the vehicle 10, a situation as to whether or not there is a loading space for housing the package to be picked up or delivered, and the like. The vehicle monitoring unit 5024 can acquire information of the situation in the vicinity of the vehicle 10, or the like from the vehicle 10. The vehicle 10 is provided with a sensor, such as a clearance sonar, configured to monitor the inside and the outside of the vehicle, thereby monitoring the situation in the vicinity of the vehicle 10, and the like.

The vehicle monitoring unit 5024 acquires the positional information of the vehicle 10 as the pick-up/delivery destination at a predetermined interval with reference to the vehicle management information table shown in FIG. 7 or through a request to the center server 400, thereby detecting that the vehicle 10 as the pick-up/delivery destination is stopped at the pick-up/delivery place. When the vehicle monitoring unit 5024 detects that the vehicle 10 as the pick-up/delivery destination is stopped at the pick-up/delivery place, the evaluation setting unit 5021 acquires the situation in the vicinity of the vehicle 10 or the loading situation inside the vehicle 10 (hereinafter, referred to as “the situation in the vicinity of the vehicle 10, or the like”) through the data communication device (not shown) in the vehicle 10. The evaluation setting unit 5021 stores (sets), in the pick-up and delivery management DB 503, an evaluation result (an example of a “first evaluation result”) for a situation evaluation item corresponding to the situation in the vicinity of the vehicle 10, or the like based on the situation acquired from the vehicle 10. As the situation evaluation item, for example, evaluation items, such as “VEHICLE IS PRESENT ON DESIGNATED PICK-UP/DELIVERY DATE AND TIME AND AT PICK-UP/DELIVERY PLACE?” and “PICK-UP/DELIVERY ARTICLE CAN BE HOUSED INSIDE THE VEHICLE?”, in the evaluation item table shown in FIG. 3 are exemplified.

When the pick-up/delivery user completes the pick-up/delivery work of the package after the first evaluation result is set, the evaluation setting unit 5021 receives an evaluation result (an example of a “second evaluation result”) for the request user on the completed pick-up/delivery from the user terminal 200 of the pick-up/delivery user. When the situation in the vicinity of the vehicle 10, or the like is changed after the vehicle 10 as the pick-up/delivery destination is stopped at the pick-up/delivery place, the second evaluation result may become lower than the first evaluation result, and the request user may not be evaluated in an authorized manner. Accordingly, when the second evaluation result is lower than the first evaluation result, the evaluation setting unit 5021 may re-evaluate the situation evaluation item. The re-evaluation of the situation evaluation item may be performed, for example, by employing the first evaluation result as the evaluation result or by employing an average value of the first evaluation result and the second evaluation result. The evaluation setting unit 5021 may notify the user terminal 200 of the pick-up/delivery user that the situation in the vicinity of the vehicle 10, or the like is changed after the vehicle 10 is stopped at the pick-up/delivery place, and may prompt the user terminal 200 of the pick-up/delivery user for re-evaluation.

The pick-up and delivery management unit 5025 receives the pick-up/delivery request from the user terminal 50 of the request user, and transmits, to the user terminal 200 of the pick-up/delivery user or the user terminal 50 of the request user, a notification relating to pick-up/delivery, for example, a notification for prompting to change the pick-up/delivery plan, to move the vehicle 10, or the like.

When the vehicle 10 is present on the pick-up/delivery date and time and at the pick-up/delivery place designated by the request user, the pick-up and delivery management unit 5025 may transmit a notification for prompting to change the pick-up/delivery plan to the user terminal 200 of the pick-up/delivery user. The pick-up and delivery management unit 5025 can acquire the positional information of the vehicle 10 as the pick-up/delivery destination with reference to the vehicle management information table shown in FIG. 7 or through a request to the center server 400. When the pick-up/delivery date and time designated by the request user is reached, the pick-up and delivery management unit 5025 acquires the positional information of the vehicle 10 as the pick-up/delivery destination, and when the acquired position of the vehicle 10 is different from the pick-up/delivery place designated by the request user, the pick-up and delivery management unit 5025 transmits a notification for prompting to change the pick-up/delivery plan to the user terminal 200 of the pick-up/delivery user. The pick-up/delivery plan is, for example, a pick-up/delivery schedule that is decided by the pick-up/delivery order of the package having the pick-up/delivery status of “UNCOMPLETED” in the pick-up and delivery information table shown in FIG. 6. When the notification for prompting to change the pick-up/delivery plan is received, the pick-up/delivery user resets the pick-up/delivery order of the package not picked up or delivered yet through the predetermined application, thereby changing the pick-up/delivery plan.

When the vehicle 10 is not present at the pick-up/delivery place designated by the request user a predetermined time before the pick-up/delivery date and time, the pick-up and delivery management unit 5025 may transmit a notification for prompting the vehicle 10 to move to the pick-up/delivery place to the user terminal 50 of the request user. The pick-up and delivery management unit 5025 acquires the positional information of the vehicle 10 as the pick-up/delivery destination the predetermined time before the pick-up/delivery date and time designated by the request user. The predetermined time can be set to, for example, a time needed until the vehicle 10 as the pick-up/delivery destination moves to the pick-up/delivery place. The time needed until the vehicle 10 as the pick-up/delivery destination moves to the pick-up/delivery place can be estimated from the distance between the current position of the vehicle 10 acquirable from the center server 400 and the pick-up/delivery place. For example, when 30 minutes are estimated to be taken until the vehicle 10 as the pick-up/delivery destination moves to the pick-up/delivery place, the pick-up and delivery management unit 5025 prompts the request user to move the vehicle 10 to the pick-up/delivery place by the pick-up/delivery date and time 30 minutes before the pick-up/delivery date and time. The vehicle 10 moves to the pick-up/delivery place by the pick-up/delivery date and time, and when the pick-up/delivery of the package becomes possible, the efficiency of the pick-up/delivery work is improved.

Any one of the functional constituent elements or a part of the processing of the pick-up and delivery management server 500 may be executed by a different computer connected to the network N1. A series of processing that is executed by the pick-up and delivery management server 500 can be executed by hardware, but may be executed by software.

Next, the center server 400 will be described. The center server 400 also has a configuration of a general computer, has the same base hardware configuration as the pick-up and delivery management server 500, and has a processor, a main storage unit, and an auxiliary storage unit (not shown). Accordingly, programs stored in the auxiliary storage unit are loaded in a work area of the main storage unit and executed, and the constituent units and the like are controlled with the execution of the programs, thereby realizing functions conforming to a predetermined purpose. The center server 400 also has a communication unit 401, and the communication unit 401 is the same as the communication unit 501 in the pick-up and delivery management server 500 and performs communication between the center server 400 and other devices (for example, the pick-up and delivery management server 500 and the like) in terms of functions.

The center server 400 has, in the auxiliary storage unit, a user information DB 403 and an authentication information DB 404 that store various kinds of information. The databases (DBs) are constructed in such a way that a program of a database management system to be executed by the processor manages data stored in the auxiliary storage unit. Each of the user information DB 403 and the authentication information DB 404 is, for example, a relational database.

Then, the user information DB 403 stores identification information of a user (for example, the pick-up/delivery user who delivers a package to the vehicle 10, or the like, or the request user who collects a delivered package) who uses the vehicle 10, a corresponding password, and the like.

The authentication information DB 404 stores the authentication information of the vehicle 10 corresponding to the above-described terminal authentication information. The authentication information of the vehicle 10 is information associated with the identification information (key ID) of the vehicle 10, and can be, for example, the identification information specific to the key unit 100 in the in-vehicle device 10A. The authentication information DB 404 may store an expiration date (including a valid time slot) of the authentication information, information of the presence or absence of invalidation of the authentication information, and the like, in addition to the authentication information of the vehicle 10. The expiration date of the authentication information may be transmitted to the user terminal 200 of the pick-up/delivery user along with the authentication information. When the expiration date of the authentication information is received, the user terminal 200 of the pick-up/delivery user can delete and invalidate the expired authentication information. The presence or absence of invalidation of the authentication information represents whether the authentication information is transmitted to the user terminal 200 of the pick-up/delivery user and is in a valid state or whether the authentication information is expired and is in an invalid state. When the authentication information is transmitted to the user terminal 200 of the pick-up/delivery user and is in the valid state, the authentication information management unit 4021 described below restrains the authentication information from being issued with the overlapped expiration date, thereby avoiding overlapped issuance of the authentication information.

In the center server 400, a controller 402 is formed as a functional unit with the execution of the programs by the above-described processor. The controller 402 performs control in relation to issuance of the authentication information to the user terminal 200 of the pick-up/delivery user, and the like. In detail, the controller 402 includes an authentication information management unit 4021 as a functional unit.

The authentication information management unit 4021 manages issuance of the authentication information for locking and unlocking the vehicle 10. In detail, the authentication information management unit 4021 receives an issuance request of the authentication information for locking and unlocking the vehicle 10 from the user terminal 200 of the pick-up/delivery user through the pick-up and delivery management server 500. The authentication information management unit 4021 receives information of the user terminal 200 of the pick-up/delivery user as an issuance destination of the authentication information along with the issuance request of the authentication information. The authentication information management unit 4021 transmits the authentication information (terminal authentication information) corresponding to the key unit 100 to the user terminal 200 of the pick-up/delivery user through the pick-up and delivery management server 500. The authentication information management unit 4021 may generate authentication information including information of the expiration date. Even though the authentication information including information of the expiration date is received, when the authentication information is expired, the key unit 100 of the in-vehicle device 10A determines that the authentication information is invalidated, and does not execute locking and unlocking of the vehicle 10.

Any one of the functional constituent elements or a part of the processing of the center server 400 may be executed by a different computer connected to the network N1. A series of processing that is executed by the center server 400 can be executed by hardware, but may be executed by software.

Flow of Processing

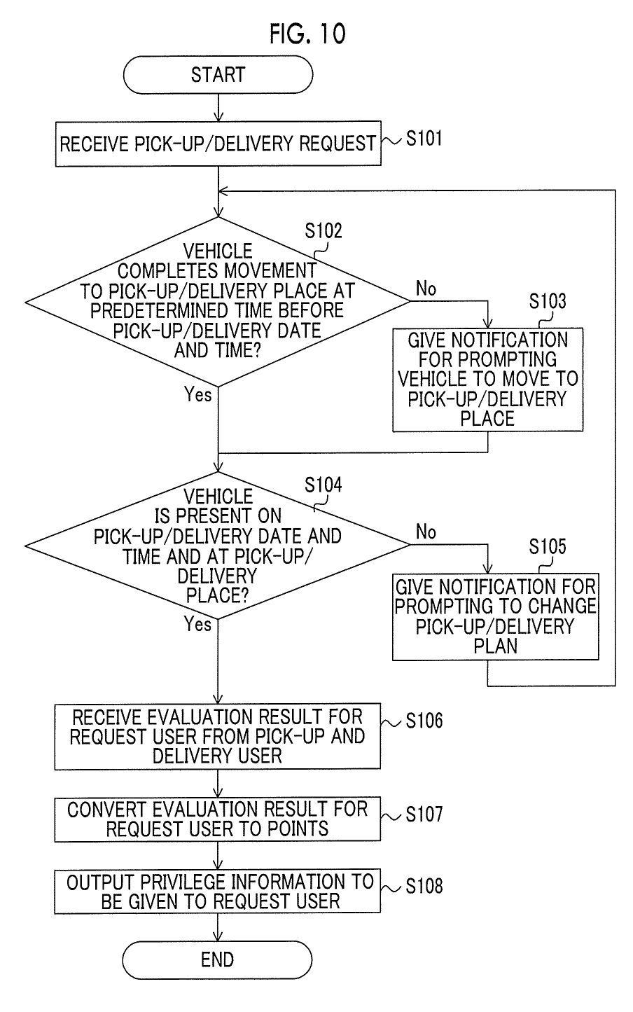

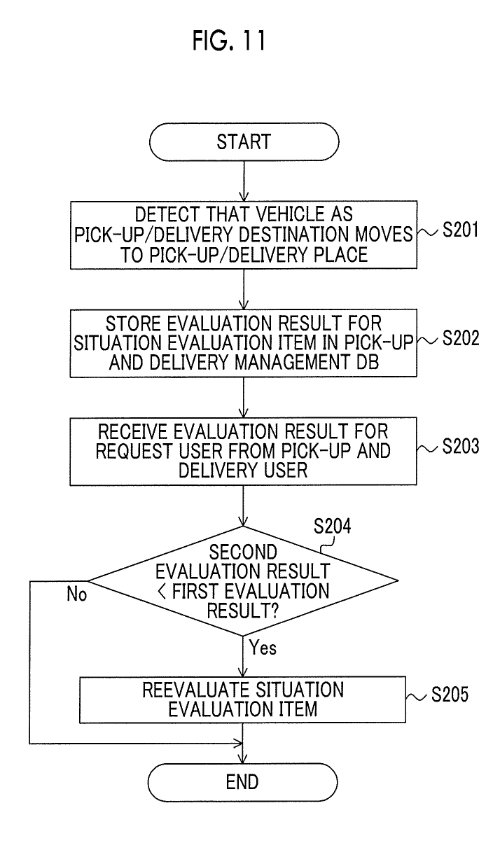

FIG. 10 is a flowchart illustrating request user evaluation processing that is executed by the pick-up and delivery management server. The request user evaluation processing shown in FIG. 10 includes processing for rewarding points based on the evaluation results for the request user and providing information of a privilege to be given to the request user based on the points after the pick-up and delivery management unit 5025 of the pick-up and delivery management server 500 receives the pick-up/delivery request. The flow of the processing starts, for example, after the pick-up and delivery management server 500 receives the pick-up/delivery request from the user terminal 50 of the request user.

First, in S101, the pick-up and delivery management unit 5025 receives the pick-up/delivery request from the user terminal 50 of the request user. For example, the pick-up and delivery management unit 5025 receives the pick-up and delivery information input on the pick-up/delivery request screen SC2 shown in FIG. 9 in the user terminal 50 of the request user, thereby receiving the pick-up/delivery request.

In S102, the pick-up and delivery management unit 5025 determines whether or not the vehicle 10 completes movement to the pick-up/delivery place the predetermined time before the pick-up/delivery date and time. The pick-up and delivery management unit 5025 can acquire the positional information of the vehicle 10 with reference to the vehicle management information table shown in FIG. 7 or through a request to the center server 400. The pick-up and delivery management unit 5025 collates the acquired positional information of the vehicle 10 with the pick-up/delivery place, thereby determining whether or not the vehicle 10 completes movement to the pick-up/delivery place. When the vehicle 10 completes movement to the pick-up/delivery place (S102: Yes), the process progresses to S104. When the vehicle 10 does not complete movement to the pick-up/delivery place (S102: No), the process progresses to S103.

In S103, the pick-up and delivery management unit 5025 transmits a notification for prompting the vehicle 10 to move to the pick-up/delivery place to the user terminal 50 of the request user. When the notification is received, the request user can start to move the vehicle 10 to the pick-up/delivery place.

In S104, the pick-up and delivery management unit 5025 determines whether or not the vehicle 10 is present on the pick-up/delivery date and time and at the pick-up/delivery place designated by the request user. When the pick-up/delivery date and time is reached, the pick-up and delivery management unit 5025 acquires the positional information of the vehicle 10 and collates the positional information of the vehicle 10 with the pick-up/delivery place, thereby determining whether or not the vehicle 10 is present on the pick-up/delivery date and time and at the pick-up/delivery place. When the vehicle 10 is present on the pick-up/delivery date and time and at the pick-up/delivery place (S104: Yes), the process progresses to S106. When the vehicle 10 is not present on the pick-up/delivery date and time and at the pick-up/delivery place (S104: No), the process progresses to S105.

In S105, the pick-up and delivery management unit 5025 transmits a notification for prompting to change the pick-up/delivery plan to the user terminal 200 of the pick-up/delivery user. When the pick-up/delivery user receives the notification for prompting to change the pick-up/delivery plan through the user terminal 200 of the pick-up/delivery user and changes the pick-up/delivery plan, the process returns to S102. The pick-up/delivery user changes the pick-up/delivery plan, and is thus highly likely to avoid a situation in which the vehicle 10 is not present when the pick-up/delivery user reaches the pick-up/delivery place. The processing of S102 to S105 is processing for improving the efficiency of the pick-up/delivery work of the pick-up/delivery user and can be omitted.

In the processing of S101 to S105, when the pick-up/delivery request of the package is received through the user terminal 200 of the pick-up/delivery user, the pick-up/delivery user moves to the pick-up/delivery place of the package with the delivery vehicle 20. The pick-up/delivery user can acquire the authentication information of the vehicle 10 stopped at the pick-up/delivery place from the center server 400 through the user terminal 200 of the pick-up/delivery user, and can unlock the vehicle 10 using the acquired authentication information. After the package to be picked up or delivered is housed in the vehicle or after the package is collected from the vehicle, the pick-up/delivery user evaluates the request user who requests for pick-up/delivery from the request user evaluation screen SC1 shown in FIG. 8. Even though the package is not picked up or delivered since the door of the vehicle 10 is hardly opened and closed due to an obstacle, there is no loading space for the package, or the like, the pick-up/delivery user evaluates the request user. The evaluation results for the request user from the pick-up/delivery user are transmitted from the user terminal 200 of the pick-up/delivery user to the pick-up and delivery management server 500.

In S106, the evaluation setting unit 5021 receives the evaluation results for the request user from the pick-up/delivery user from the user terminal 200 of the pick-up/delivery user. The received evaluation results are stored in the pick-up and delivery management DB 503 and are used for calculating points to be rewarded to the request user.

In S107, the user evaluation unit 5022 converts the evaluation results for the request user stored in the pick-up and delivery management DB 503 in S106 to points for each evaluation item based on the evaluation item table shown in FIG. 3. The points to be rewarded to the request user may be, for example, a total of points converted for each evaluation item, or a total of points converted while giving a weight for each evaluation item. The user evaluation unit 5022 adds the points to be rewarded to the earned points of the request user to be rewarded to update the earned points in the request user table shown in FIG. 4.

In S108, the privilege providing unit 5023 provides information of privileges to be given to the request user based on the earned points of the request user. The privilege providing unit 5023 can transmit information of privileges to be given to the request user to the user terminal 50 of the request user, for example, through a message, such as electronic mail, a short message service (SMS), or a multimedia messaging service (MMS), and can provide information of privileges to the request user. The privilege providing unit 5023 may provide information of privileges to be given and may receive a request to use privileges when the request user newly requests for pick-up/delivery of a package. The points are rewarded to the request user based on the evaluation results for the request user from the pick-up/delivery user, privileges based on the earned points are provided to the request user, and the processing shown in FIG. 10 ends.

The embodiment describes an example where the evaluation results for the request user from the pick-up/delivery user are converted to the points, the points are rewarded to the request user, and information of privileges is given to the request user based on the rewarded points. The disclosure is not limited to the example of the embodiment, and the information processing system 1 may provide information of privileges to the request user based on the evaluation results for the request user from the pick-up/delivery user. In this case, the evaluation results and the privileges to be given to the request user are associated with each other.

### Functional Effects of First Embodiment

The information processing system 1 provides information of privileges to be given to the request user based on the evaluation results for the request user from the pick-up/delivery user. Since the request user can receive various privileges based on the evaluation results, the request user is motivated to stop the vehicle 10 at the designated pick-up/delivery place on the designated pick-up/delivery date and time to improve the evaluation results. Accordingly, the efficiency of the pick-up/delivery work with the vehicle 10 as a hand-over place of the pick-up/delivery article is improved.

The information processing system 1 may reward points to the request user based on the evaluation results for the request user from the pick-up/delivery user and may provide information of privileges to the request user based on the rewarded points. Even in this case, the request user is motivated to improve the evaluation results, and the efficiency of the pick-up/delivery work is improved.

When the vehicle 10 is not present on the pick-up/delivery date and time and at the pick-up/delivery place designated by the request user, the information processing system 1 transmits a notification for prompting to change the pick-up/delivery plan to the user terminal 200 of the pick-up/delivery user who picks up or delivers the package. With this, since the pick-up/delivery user can change the pick-up/delivery plan before the pick-up/delivery user reaches the pick-up/delivery place, the efficiency of the pick-up/delivery work is improved.

When the vehicle is not present at the pick-up/delivery place designated by a user a predetermined time before the pick-up/delivery date and time designated by the user, the information processing system 1 transmits a notification for prompting the vehicle to move to the pick-up/delivery place to the terminal of the user. With this, the information processing system 1 can suppress the occurrence of a situation in which the vehicle 10 is not present as the pick-up/delivery destination on the pick-up/delivery date and time and at the pick-up/delivery place.

### Second Embodiment

In a second embodiment, the information processing system 1 determines authorization of the evaluation results for the request user from the pick-up/delivery user, and when the evaluation results from the pick-up/delivery user are lacking in authorization, re-evaluates the request user. Processing other than the processing for determining authorization of the evaluation results from the pick-up/delivery user and re-evaluating the request user is the same as the evaluation processing of the request user in the first embodiment, and thus, detailed description will be omitted.

FIG. 11 is a flowchart illustrating re-evaluation processing of the request user that is executed by the pick-up and delivery management server. A flow of the processing starts, for example, after the pick-up and delivery management server 500 detects that the vehicle 10 as the pick-up/delivery destination moves to the pick-up/delivery place.

First, in S201, the vehicle monitoring unit 5024 detects that the vehicle 10 as the pick-up/delivery destination moves to the pick-up/delivery place. The vehicle monitoring unit 5024 can acquire the positional information of the vehicle 10 as the pick-up/delivery destination, for example, at a predetermined interval through a request to the center server 400. The vehicle monitoring unit 5024 may detect that the vehicle 10 as the pick-up/delivery destination moves to the pick-up/delivery place when the acquired positional information of the vehicle 10 coincides with the pick-up/delivery place designated by the request user.

In S202, the vehicle monitoring unit 5024 acquires the situation in the vicinity of the vehicle 10 or the loading situation inside the vehicle 10 from the vehicle 10. The vehicle monitoring unit 5024 stores (sets), in the pick-up and delivery management DB 503, the evaluation result (first evaluation result) for the situation evaluation item based on the situation in the vicinity of the vehicle 10, or the like acquired from the vehicle 10.

In S203, the evaluation setting unit 5021 receives the evaluation result (second evaluation result) for the request user from the pick-up/delivery user from the user terminal 200 of the pick-up/delivery user. The received evaluation result is stored in the pick-up and delivery management DB 503.

In S204, the evaluation setting unit 5021 compares the first evaluation result for the situation evaluation item set in S202 with the second evaluation result for the situation evaluation item received from the user terminal 200 of the pick-up/delivery user in S203. The evaluation setting unit 5021 determines whether or not the second evaluation result is lower than the first evaluation result. The evaluation setting unit 5021 converts the first evaluation result and the second evaluation result for the situation evaluation item to points based on the evaluation item table shown in FIG. 3, and when a total of the points of the second evaluation result is smaller than a total of the points of the first evaluation result, can determine that the second evaluation result is lower than the first evaluation result. When the second evaluation result is lower than the first evaluation result (S204: Yes), the process progresses to S205. When the second evaluation result is not lower than the first evaluation result (S204: No), the processing shown in FIG. 11 ends.

In S205, the evaluation setting unit 5021 re-evaluates the situation evaluation item. The re-evaluation of the situation evaluation item may be performed, for example, by employing the first evaluation result or by employing an average value of the first evaluation result and the second evaluation result. When the situation evaluation item is re-evaluated, the processing shown in FIG. 11 ends.

In S204, the evaluation setting unit 5021 may determine whether or not the second evaluation result is lower than the first evaluation result for each situation evaluation item. In this case, in S205, the evaluation setting unit 5021 may re-evaluate a situation evaluation item that the second evaluation result is determined to be lower than the first evaluation result.

### Functional Effects of Second Embodiment

When the information processing system 1 detects that the vehicle 10 is stopped at the pick-up/delivery place of the package, the information processing system 1 acquires information of the situation in the vicinity of the vehicle 10 or the loading situation inside the vehicle 10, and evaluates the situation evaluation item in advance based on a situation when the vehicle 10 is stopped at the pick-up/delivery place. For this reason, the information processing system 1 can properly evaluate the request user based on a situation when the vehicle 10 is stopped.

Even though the situation in the vicinity of the vehicle 10, or the like is changed after the vehicle 10 is stopped, the information processing system 1 re-evaluates the request user based on the first evaluation result and the second evaluation result, thereby performing proper evaluation of the request user according to a situation when the vehicle 10 is stopped.

Recording Medium

A program that causes a computer or other machines or apparatuses (hereinafter, referred to as a computer or the like) to implement the above-described issuance control can be recorded in a recording medium that is readable by the computer or the like. The computer functions as the above-described center server 400 by causing the computer or the like to read and execute the program of the recording medium.

Here, the recording medium that is readable by the computer or the like refers to a non-transitory recording medium that stores information such as data or programs by means of electric, magnetic, optical, mechanical, or chemical actions and is readable by the computer or the like. Among such recording mediums, examples of a recording medium detachable from a computer or the like may include a flexible disk, a magneto-optical disk, a compact disc-read only memory (CD-ROM), a compact disc-rewritable (CD-R/W), a DVD, a Blu-ray disk, a digital audio tape (DAT), an 8 mm tape, a memory card such as a flash memory, and the like. Furthermore, examples of a recording medium fixed to the computer or the like may include a hard disk, a ROM, and the like. In addition, a solid state drive (SSD) may be used as either a recording medium that is detachable from the computer or the like or a recording medium that is fixed to the computer or the like.

What is claimed is:

1. An information processing system comprising:
an evaluation setting unit configured to, on evaluation items for evaluating a user who requests a pick-up and delivery agent who picks up or delivers the package to pick-up the package from an inside of a vehicle cabin of a vehicle, receive and store evaluation results for the evaluation items from a terminal of the pick-up and delivery agent who picked up or delivered the package; and
a privilege providing unit configured to provide, based on the evaluation results, information of a privilege to be given to the user who has requested the pick-up or delivery of the package.

2. The information processing system according to claim 1, further comprising a user evaluation unit configured to reward points to the user based on the evaluation results,
wherein the privilege providing unit is configured to provide the information of the privilege to be given to the user based on the rewarded points.

3. The information processing system according to claim 1, further comprising a vehicle monitoring unit configured to acquire information of a situation in a vicinity of the vehicle or a loading situation inside the vehicle,
wherein the evaluation setting unit is configured to, when detection is made that the vehicle is stopped at a pick-up or delivery place designated by the user, set a first evaluation result for a situation evaluation item corresponding to the situation in the vicinity of the vehicle or the loading situation inside the vehicle acquired by the vehicle monitoring unit among the evaluation items.

4. The information processing system according to claim 3, wherein the evaluation setting unit is configured to, when a second evaluation result for the situation evaluation item included in the evaluation results for the evaluation items received from the terminal of the pick-up and delivery agent who has picked up or delivered the package is lower than the first evaluation result, re-evaluate the situation evaluation item based on the first evaluation result and the second evaluation result for the situation evaluation item.

5. The information processing system according to claim 3, wherein the situation evaluation item includes at least one of (i) ease of access to the pick-up or delivery place designated by the user, (ii) presence or absence of a change request of pick-up or delivery date and time or the pick-up or delivery place designated by the user, and (iii) package housability inside the vehicle.

6. The information processing system according to claim 1, wherein the evaluation item includes at least one of (i) presence or absence of a vehicle on pick-up or delivery date and time and at the pick-up or delivery place designated by the user, and (ii) presence or absence of a change request of the pick-up or delivery date and time or the pick-up or delivery place designated by the user.

7. The information processing system according to claim 3, further comprising a pick-up and delivery management unit configured to, when the vehicle is not present on a pick-up or delivery date and time and at the pick-up or delivery place designated by the user, transmit notification for prompting to change a pick-up and delivery plan to the terminal of the pick-up and delivery agent who picks up or delivers the package.

8. The information processing system according to claim 7, wherein the pick-up and delivery management unit is configured to, when the vehicle is not present at the pick-up or delivery place a predetermined time before the pick-up or delivery date and time, transmit notification for prompting the vehicle to move to the pick-up or delivery place to a terminal of the user.

9. The information processing system according to claim 1, wherein the privilege to be given to the user includes any one of (i) a discount of a delivery charge of the package, (ii) delivery with priority over other users, and (iii) a gift.

10. An information processing method comprising:
with a computer, on evaluation items for evaluating a user who requests a pick-up and delivery agent who picks up or delivers the package to pick-up the package from an inside of a vehicle cabin of a vehicle, receiving and storing evaluation results for the evaluation items from a terminal of the pick-up and delivery agent; and
with the computer, providing, based on the evaluation results, information of a privilege to be given to the user who has requested the pick-up or delivery of the package.
